(19) United States
(12) Patent Application Publication
(10) Pub. No.: US 2011/0082719 A1
(43) Pub. Date: Apr. 7, 2011

(54) SYSTEM AND METHOD FOR DETERMINING AGGREGATED TRACKING METRICS FOR USER ACTIVITIES

(75) Inventor: Rajiv Dutta, Saratoga, CA (US)

(73) Assignee: TOKONI INC., CUPERTINO, CA (US)

(21) Appl. No.: 12/575,043

(22) Filed: Oct. 7, 2009

(51) Int. Cl. G06Q 10/00; G06Q 50/00; G06F 17/30

(52) U.S. Cl. 705/7.29; 707/E17.01

(57) ABSTRACT

In various exemplary embodiments, a system and method to provide tracking of user interactions and activities with subscribed-to media content is provided. Tracking data which reflects both online and offline activities with media content is accessed. The tracking data is processed to determine a plurality of tracking media associated with the media content. The plurality of tracking metrics is aggregated to generate an aggregated tracking metric. The aggregated tracking metric may comprise two or more of an audience metric, a frequency metric, and an engagement metric.

### TECHNICAL FIELD

The present application relates generally to the field of computer technology and, in a specific exemplary embodiment, to a system and method for determining aggregated tracking metrics for user activities.

### BACKGROUND

Tracking user activities with various media and media types provides a content provider with valuable information. However, the tracking of offline user activities may be difficult. Conventionally, tracking mechanisms monitor only online activities.

Furthermore, conventional tracking systems typically monitor a single metric such as time spent on a site or web pages viewed. In situations where a revenue share is based on this single metric, manipulation of the metric may be easily accomplished. For example, software programs may be established that continuously view particular pages of media in order to increase the metric for that media.

### BRIEF DESCRIPTION OF DRAWINGS

Various ones of the appended drawings merely illustrate exemplary embodiments of the present invention and cannot be considered as limiting its scope.

FIG. 1 is a block diagram illustrating an exemplary embodiment of a high-level, client-server-based network architecture of a system used to determine aggregated tracking metrics for user activities.

FIG. 2 is a block diagram illustrating an exemplary embodiment of an aggregated media system of the network architecture of FIG. 1.

FIG. 3 is a block diagram illustrating an exemplary embodiment of systems of the aggregated media system of FIG. 2.

FIG. 4 is a block diagram illustrating an exemplary embodiment of an account system.

FIG. 5 is a block diagram illustrating an exemplary embodiment of a content acquisition system.

FIG. 6 is a block diagram illustrating an exemplary embodiment of a content distribution system.

FIG. 7 is a block diagram illustrating an exemplary embodiment of a tracking system.

FIG. 8 is a flowchart illustrating an exemplary method for tracking media content interactions by subscribers.

FIG. 9 is a flowchart illustrating an exemplary method for performing tracking metric analysis.

FIG. 10 is a simplified block diagram of a machine in an exemplary form of a computing system within which a set of instructions for causing the machine to perform any one or more of the methodologies discussed herein may be executed.

### DETAILED DESCRIPTION

The description that follows includes illustrative systems, methods, techniques, instruction sequences, and computing machine program products that embody the present inventive subject matter. In the following description, for purposes of explanation, numerous specific details are set forth to provide an understanding of various embodiments of the inventive subject matter. It will be evident, however, to those skilled in the art that embodiments of the inventive subject matter may be practiced without these specific details. Further, well-known instruction instances, protocols, structures, and techniques have not been shown in detail.

As used herein, the term “or” may be construed in either an inclusive or exclusive sense. Similarly, the term “exemplary” is construed merely to mean an example of something or an exemplar and not necessarily a preferred or ideal means of accomplishing a goal. Each of a variety of exemplary embodiments is discussed in detail, below.

Exemplary embodiments provide systems and methods for tracking subscriber interactions and activities with subscribed-to media content. Offline tracking data is obtained. Tracking data which reflects both online and offline activities with media content is aggregated. The tracking data is processed to determine tracking metrics associated with each media content for each subscriber. The tracking metrics may then be used to perform further analysis. The tracking metric may comprise, in one embodiment, a combination of two or more of an audience metric, a frequency metric, and an engagement metric.

By utilizing the aggregated tracking metrics, a more comprehensive value may be attributed to each media and media content. As a result, further use of the tracking metrics may be more accurate. For example, revenue sharing between content providers based on two or more of the aggregated tracking metrics may be more accurate over a system based only on a single metric.

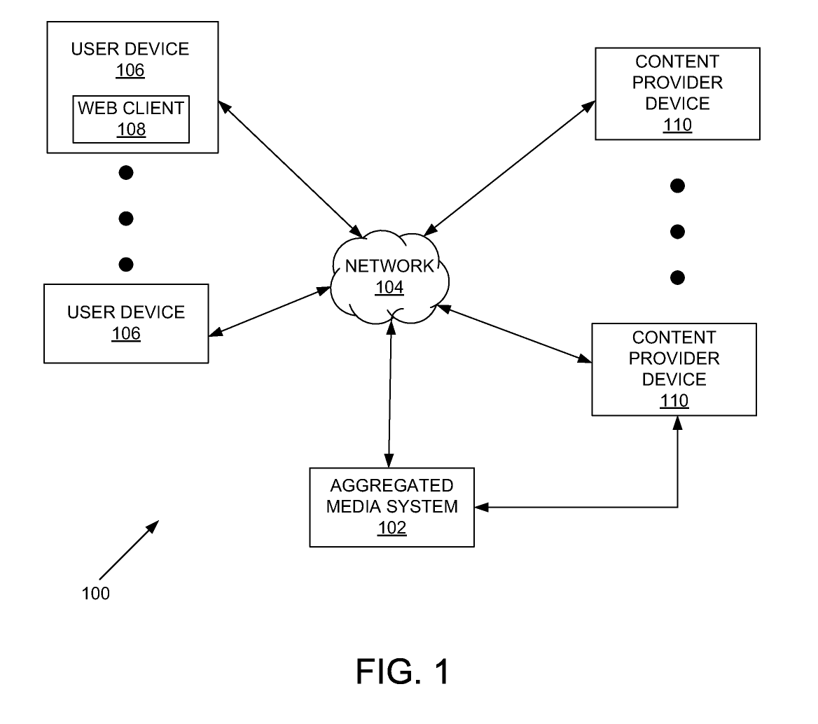

With reference to FIG. 1, an exemplary embodiment of a high-level client-server-based network architecture 100 for determining aggregated tracking metrics for user activities is shown. An aggregated media system 102 is coupled via a network 104 (e.g., the Internet or Wide Area Network (WAN)) to one or more user devices 106. In exemplary embodiments, the aggregated media system 102 manages distribution of media content, manages tracking of both online and offline user activities, and utilizes the tracking data to generate aggregated tracking metrics for each media content. The tracking metrics may then be used in further analysis such as, for example, determining a revenue share or determining a subscription plan price. The various systems and processes that allow the generation of tracking metrics will be discuss in more detail herein.

Media content comprises any content with which a respective subscriber may want to interact. Examples of media content include, but are not limited to, video (e.g., movies, television shows or series, premium video channels such as HBO), print (e.g., newspaper, magazines, journals, books), and online content (e.g., electronic documents) that a subscriber may wish to consume (e.g., view or read).

The user devices 106 are used to access subscribed-to media content via the network 104. FIG. 1 illustrates, for example, a web client 108 operating via a browser (e.g., such as the Internet Explorer® browser) on one of the user devices 106. The user device 106 may comprise a mobile or handheld device (e.g., cellular phone, laptop, offline reader device), desktop device (e.g., desktop computer), or any device that can communicate over the network 104 to access media. Each subscriber may have more than one user device 106 associated with them. For example, the subscriber may have a cellular phone, a laptop, a set-top box, and an e-book reader. Thus, the subscriber may access media content via any of these user devices 106.

The media content may be provided from multiple content providers. In some embodiments, the media content is provided from content provider devices 110. In one embodiment, the media content is provided via the network 104 to the aggregated media system 102 for distribution to subscribers. In another embodiment, the media content is directly provided to subscribers at their user device 106 from the content provider device 110. Furthermore, the media content may be provided directly to the aggregated media system 102 from the content provider or content provider device 110 (e.g., provided to the aggregated media system 102 without the use of the network 104).

While the exemplary architecture 100 of FIG. 1 employs a client-server architecture, a skilled artisan will recognize that the present disclosure is not limited to such an architecture. The exemplary architecture 100 can equally well find application in, for example, a distributed or peer-to-peer architecture system. The aggregated media system 102 may also be implemented as standalone systems or standalone software programs operating under a separate hardware platform.

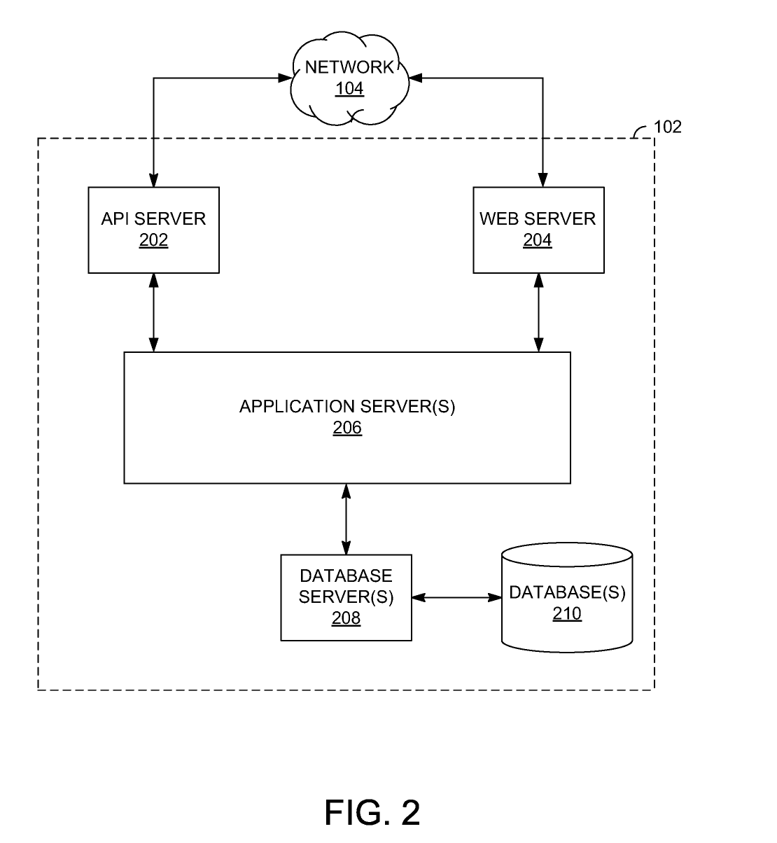

FIG. 2 is a block diagram illustrating an exemplary embodiment of the aggregated media system 102 of the network architecture of FIG. 1. As illustrated, an Application Program Interface (API) server 202 and a web server 204 are coupled to, and provide programmatic and web interfaces respectively to, one or more application servers 206 of the aggregated media system 102. The application servers 206 host a plurality of systems, which may comprise one or more modules, applications, or engines, each of which may be embodied as hardware, software, firmware, or any combination thereof.

The application servers 206 are, in turn, coupled to one or more database servers 208 facilitating access to one or more database(s) 210. The databases 210 may store subscription account information, as well as tracking data received for online and offline user activities. The databases 210 may also store media content provided by the content providers. The media content includes electronic copies of print media (e.g., newspaper, magazines), video (e.g., television series or programs), and online media (e.g., online journals, online newspaper). Virtually any content that a subscriber may be interested in obtaining may be provided as media content.

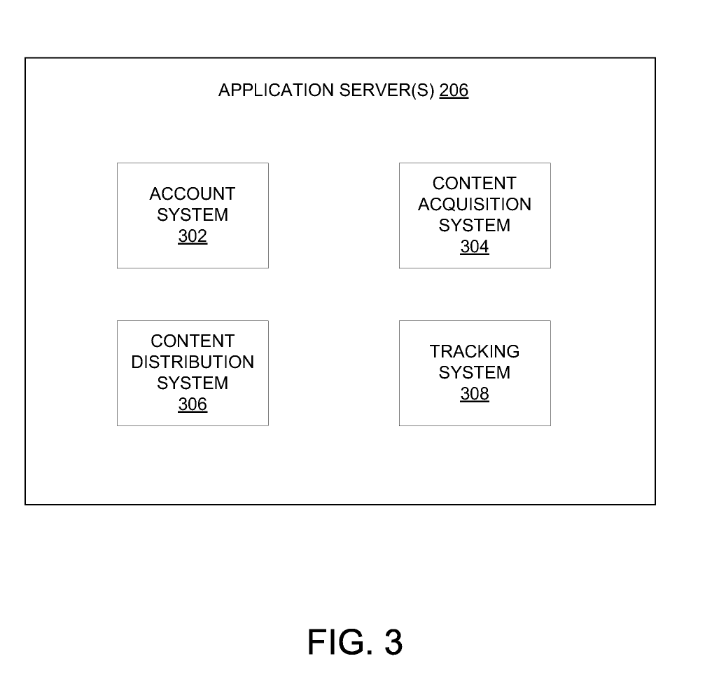

FIG. 3 is a block diagram illustrating exemplary systems of the one or more application servers 206 of the aggregated media system 102. The systems comprise an account system 302, a content acquisition system 304, a content distribution system 306, and a tracking system 308. The account system 302 manages user and content provider accounts, as well as subscription plans and media bundles. The content acquisition system 304 manages the acquisition of media content from various content providers, while the content distribution system 306 manages distribution of the media content. The tracking system 308 manages the tracking of user activities with respect to the media both online and offline and generates aggregated tracking metrics for each media content. Each of these systems will be discussed in more detail below.

It should be noted that the systems of FIG. 3 are exemplary. Alternative embodiments may comprise more, less, or functionally equivalent (but differently named or combined) systems.

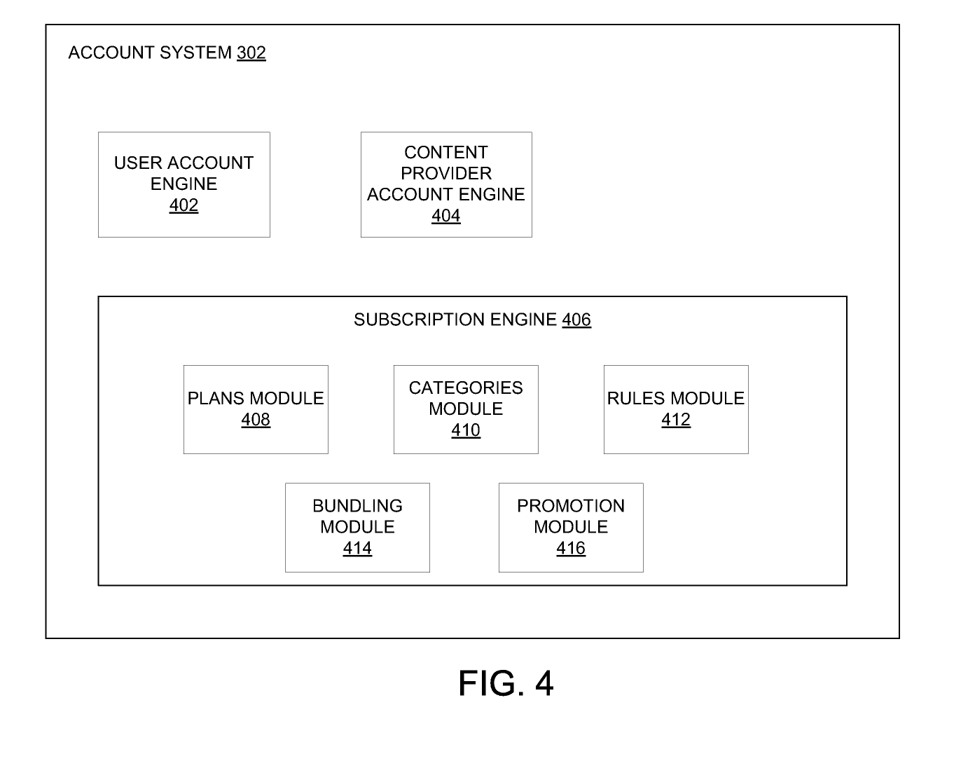

FIG. 4 is a block diagram illustrating an exemplary embodiment of an account system (e.g., the account system 302). The account system 302 manages user and content provider accounts as well as subscription plans and media bundles. The account system 302 comprises a user account engine 402, a content provider account engine 404, and a subscription engine 406. The user account engine 402 handles subscriber accounts. In exemplary embodiments, the user account engine 402 establishes a user account for each subscriber and maintains account information for each user account. The account information includes, for example, subscriber's identity, contact information, billing and payment information, online access information (e.g., user names and passwords), and information about one or more media bundles associated with each subscriber.

The content provider account engine 404 handles content provider accounts. In exemplary embodiments, accounts are established for content providers that provide content to the aggregated media system. These content providers may be provided revenue in exchange for providing content or access to content. By maintaining content provider accounts, the management of revenues may be easily managed. It is noted that content providers need not have an account established with the aggregated media system in order to provide media content.

The subscription engine 406 manages subscriptions and allows for the generation of media bundles. In exemplary embodiments, when a subscriber subscribes to the aggregated media system, the subscriber is presented with a plurality of subscription plans. These subscription plans are established based on rules and categories by a plans module 408. For example, a basic subscription plan may allow a subscriber to subscribe to a national newspaper, three local newspapers, one sports magazine, and one men's interest magazine, whereas another subscription plan (e.g., a sports subscription plan) allows a subscriber to subscribe to three sports magazines, two sports sections from newspapers, and two television programs from one sports channel. Furthermore, the subscription plan may allow an ad-hoc purchase of a single issue of a newspaper or magazine online which may be billed to the subscriber's online account.

The rules associated with the selected subscription plan may include a time component. For example, a subscription plan may allow a subscription to a media component for one day, one week, one month, or any other period of time.

In some embodiments, the plans module 408 may generate subscription plans based on user inputs. For example, the subscriber may indicate an interest area and number of media to which the subscriber desires to subscribe. The plans module 408 may customize a subscription plan to the subscriber and determine a subscription price. As such, an infinite amount of subscription plans may be available to the subscriber.

In exemplary embodiments, media and media components (e.g., a single article, section, or episode of a media) are categorized into one or more content categories established by the aggregated media system by a categories module 410. Content categories include, for example, newspapers, magazines, journals, television series, television program (e.g., a single instance of a show or a one-time event), online newspapers, online magazines, and online video series. The content categories may be further divided into global, national, regional, and local categories. Thus, a media may be categorized under multiple content categories. For example, The New York Times may be categorized as a national, regional (e.g., to the East Coast), and local (e.g., to New York) newspaper, while an online version of The New York Times may be categorized as a national, regional, and local online newspaper. Furthermore, sections of the New York Times may be categorized as well. For example, a sports section of the New York Times may be categorized under a sports category, a local sports category, a regional sports category, and a national sports category. The categories module 410 manages the categorization of each media and media component. In a video example, the content categories may also include sub-categories. So in a television analogy, the subscriber may subscribe to a channel (e.g., HBO), a series (e.g., Six Feet Under), or a specific episode or program (e.g., Tyson fight).

A rules module 412 ensures that a subscriber confirms to the rules associated with a selected subscription plan when establishing their customized media bundle. Continuing with the basic subscription plan example, the rules module 412 checks that a subscriber's selection of media includes one national newspaper, three local newspapers, one sports magazine, and one men's interest magazine. If the selection does not conform with these rules, then an error message is sent to the subscriber, and the subscriber may be required to adjust their selection until a conforming set of media is selected. Alternatively, the subscriber may be asked if they want to change their subscription plan to a subscription plan with rules that conform with the selected media.

Once the selection conforms with the rules of the selected subscription plan, a bundling module 414 will establish a customized (rules-based) bundle for the subscriber. Data associated with the customize bundle will be associated with the subscriber's account, and the subscriber will have access to the selected media of the customized bundle.

A promotion module 416 incorporates promotions from a content provider into the selected subscription plan. Because the media content is generally paid-for content, promotions currently offered by the content provider are integrated into the subscription plan. For example if The New York Times is offering the first three months free, this promotion is integrated into the selected subscription plan (e.g., a reduction in subscription price).

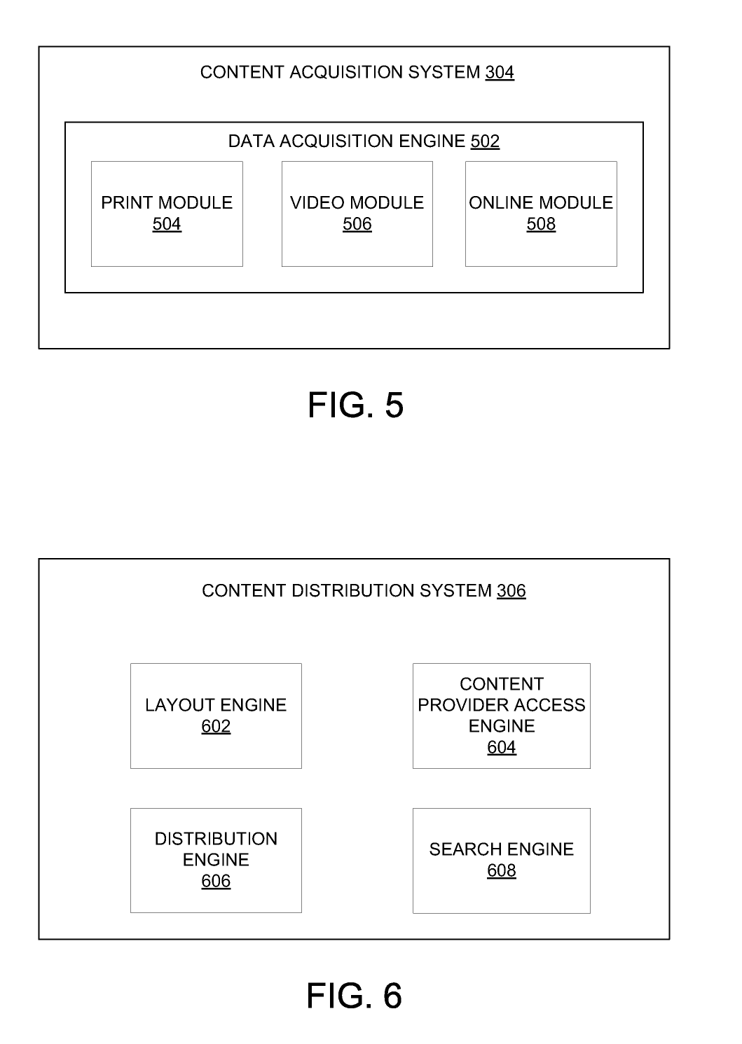

FIG. 5 is a block diagram illustrating an exemplary embodiment of a content acquisition system 304. The content acquisition system 304 comprises a data acquisition engine 502 including a print module 504, a video module 506, and an online module 508. Other modules may be provided in the data acquisition engine 502 to accommodate other forms of media content. Each of the modules 504, 506, and 508 obtains their respective media content for distribution to subscribers. The obtained media content may be stored in one or more databases (e.g., the database 210).

Because media comes from various sources, different modules are used to obtain media content. For example, the print module 504 is configured to obtain print content in various forms, such as a PDF version or a reformatted digital version of the print content. In another example, the video module 506 may be configured to receive streaming data representing a video program or receive digital television transmissions. The online module 508 receives web-based content. The web-based content may be streamed to the aggregated media system for storage in a database (e.g., the database 210). Alternatively, links to the web-based content at the content provider device 110 may be maintained by the aggregated media system.

In some embodiments, the acquired content may comprise layout metadata. For example, the metadata may be associated with the News Industry Text Format or PDF. In other embodiments, a publisher template may be associated with the acquired media content. The publisher templates provide layout rules and style information which cover various portions of the media content (e.g., story hierarchy, adjacency, advertising, front page, internal pages, spreads).

FIG. 6 is a block diagram illustrating an exemplary embodiment of a content distribution system (e.g., the content distribution system 306). The content distribution system 306 comprises a layout engine 602, a content provider access engine 604, a distribution engine 606, and a search engine 608.

The layout engine 602 formats content from the aggregated media system into a form that will be viewable on a specific user device of the subscriber receiving the media content. In some embodiments, the media content may comprise layout metadata. In these embodiments, the layout engine 602 formats the media content in a preferred or indicated format based on the metadata (e.g., News

Industry Text Format, PDF). In other embodiments, a publisher template may be utilized by the layout engine 602. The publisher templates, as well as the metadata, provide layout rules and style information which cover various portions of the media content (e.g., front page, internal pages, spreads). The layout rules and style are combined with information regarding a display device (e.g., the user device 106) associated with the subscriber to format the media content. The formatted media content may comprise, for example, flowable text or columns, HTML, and print. The layout engine 602 further formats advertising from print editions to digital editions for display (e.g., with the subscribed-to media).

The content provider access engine 604 provides access to media content from the content provider (e.g., via the content provider device 110). In exemplary embodiments, when the subscriber is logged into their account with a particular content provider, the content provider access engine 604 also allows access to media content from the particular content provider via the aggregated media system without having to log in with the aggregated media system. Alternatively, when the subscriber is logged into the aggregated media system, the subscriber may access the media content directly from the content provider without having to log in with the content provider. In yet other embodiments, the aggregated media system 102 maintains links to the media content at the content provider device 110. The content provider access engine 604 maintains these links.

The distribution engine 606 provides media content to the user device(s) associated with a subscriber. For example, the distribution engine 606 provides a copy of an electronic book to an offline reader device or a television program to an Internet enabled television. In various embodiments, the distribution engine 606 will obtain the formatted media content from the layout engine 602 and forward the formatted content to the user device.

The search engine 608 allows a subscriber to search for particular media content. The media content being provided to the subscriber may be extensive. If the subscriber is only interested in one particular portion of the media content, the subscriber has an ability to search for that particular portion. For example, the subscriber may subscribe to the New York Times, but may not want to read all the media content. Instead, the subscriber may only be interested in a particular story. In this case, the subscriber can enter keywords and the search engine 608 will find one or more pieces of content that satisfy the search. The search result may then be served by the distribution engine 606 to the subscriber.

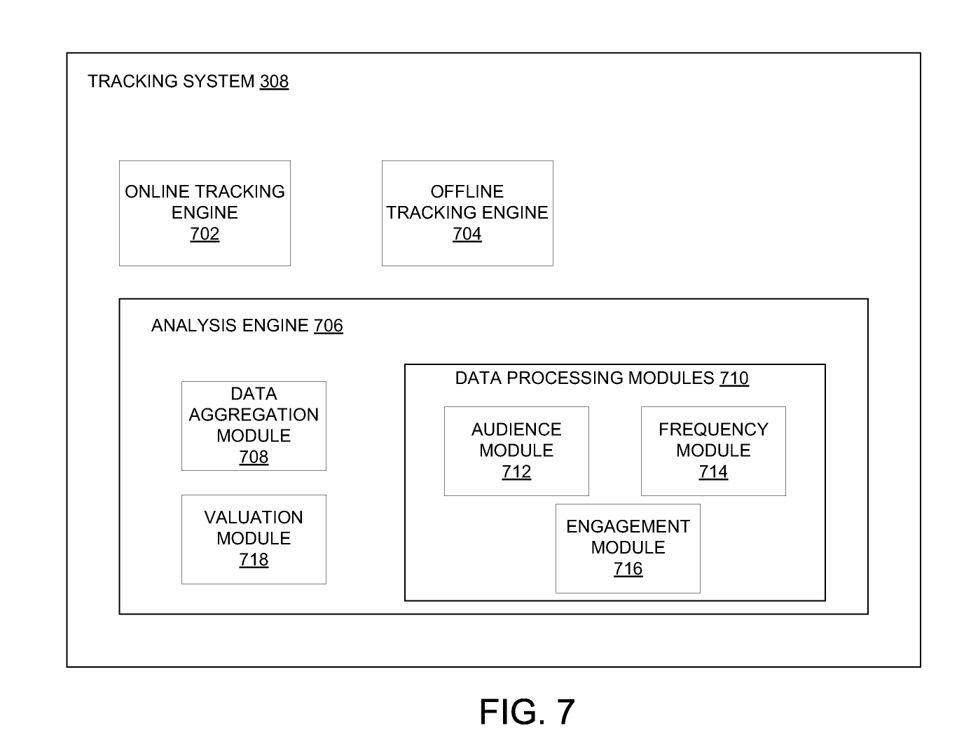

FIG. 7 is a block diagram illustrating an exemplary embodiment of a tracking system (e.g., the tracking system 308). The tracking system 308 tracks activities of subscribers with respect to the various media content. In one example, the results of the tracking system 308 may be used for determining revenue among content providers. If the subscriber's media bundle includes four newspapers, revenues may be divided between the four newspapers based individually on the subscriber's activities or collectively amongst a plurality of subscribers' activities with respect to those four newspapers. For example, if one media receives 80% of a subscriber's activities in a subscription plan, that media may receive 80% of the revenue from that subscription plan.

In another scenario, the tracking data may be used to determine subscription plan pricing. For example, if one particular content provider has a much higher activity rate than others, subscriptions for that media content or media from that content provider may be priced higher by the aggregated media system 102. The tracking data may be used for other functions as well, such as, for example, ranking media content.

In exemplary embodiments, the tracking system 308 comprises an online tracking engine 702, an offline tracking engine 704, and an analysis engine 706. The analysis engine 706 further comprises a data aggregation module 708, data processing modules 710 (including an audience module 712, a frequency module 714, and an engagement module 716), and a valuation module 718.

The online tracking engine 702 tracks online activities of subscribers. Examples of online tracking technologies which may be used include cookies, clickstreams, and web analytics. For example, the raw online tracking data may indicate a timestamp, an identifier of the subscriber that is being tracked, and an action being performed, or types of interactions with the media content. Because online activities may occur through the aggregated media system 102 (e.g., media content accessed via the aggregated media system 102), the online tracking engine 702 can easily track these activities. In other embodiments, online activities may be cached locally at the user device and periodically sent to the online tracking engine 702. The raw online tracking data may be stored to a database (e.g., the database 210) for later analysis.

The offline tracking engine 704 tracks offline activities of subscribers. In exemplary embodiments, an offline tracking application may be provided to a user device (e.g., user device 106) of the subscriber which will track frequency (e.g., number of times media content is accesses) and engagement of the subscriber (e.g., timestamp for when the media content is accessed and types of interactions with the media content), as well as, other activities performed by the subscriber. The user device caches or stores the tracking data in a local store until it is communicatively coupled with the aggregated media system 102. Once coupled (e.g., via the network 104), the offline tracking engine 704 obtains the raw tracking data and stores the raw offline tracking data to a database (e.g., the database 210) for later analysis. The local store may also store media content downloaded from the aggregated media system 102 as well as any updates to the media content. The local store may be a file, database, or any storage mechanism provided by a client operating environment (e.g., Google Gears, HTML 5 storage mechanism, database provided by flash runtime).

In various embodiments, the offline tracking engine 704 provides the offline tracking application to the user device that monitors and tracks activities of the subscriber with downloaded media content provided via the aggregated media system 102. The application also instructs the user device to cache the tracking data and send the tracking data when the user device is communicatively coupled to the aggregated media system 102. Thus, a user may download, for example, a copy of the Wall Street Journal (WSJ) onto a portable device. The offline tracking application may then track and store data associated with the user's interactions with the WSJ (e.g., timestamp of when each article was accessed, actions performed with respect to the each article such as highlighting, clicking through, or accessing an ad).

The analysis engine 706 performs analysis on the stored online and offline tracking data. The data aggregation module 708 accesses the stored online and offline tracking data and aggregates the tracking data. Thus, the data aggregation module 708 may, at certain time periods (e.g., daily, weekly, monthly), take the raw tracking data and convert the tracking data into “real world” data. For example, the data aggregation module 708 may take the timestamp, user ID, and action associated with each piece of raw tracking data and convert it into a time period in which a user clicked on a certain number of pages of a particular media content and an amount of time spent on each page. For example, the “real world” data may indicate that Sue viewed a particular article on the WSJ for 10 minutes. The converted data may then be aggregated for each content media or for each user over a period of time. As a result, the aggregated tracking data may indicate that Sue spent 22 hours on the WSJ and spent 5,000 clicks on the WSJ with N numbers of click-throughs and bought items from X number of ads in a one month period.

Additionally, tracking data of multiple related media components may be aggregated to generate an aggregated tracking data for a media. For example, tracking data for various sections of The New York Times may be aggregated in order to obtain an aggregated metric for The New York Times as a whole. Any manner of combining tracking data may be utilized by the data aggregation module 708.

The aggregated tracking data is then process through the various data processing modules 710 (e.g., the audience module 712, the frequency module 714, and the engagement module 716) to determine respective metrics. It should be noted that in some embodiments, the aggregated tracking data may be received and accessed by the data aggregation module 708 in real-time or substantially real-time.

The audience module 712 determines an audience metric for each media or media content. The audience metric considers the uniqueness of the individuals accessing the media content. For example, a subscriber with a large subscription plan (e.g., subscribes to a large number of media) is distinct from a subscriber that only subscribes to a single, particular media. Additionally, characteristics or demographics of the subscriber may be considered when determining the audience metric. These characteristics may include, for example, any one or more of gender, geography, income level, education level, or occupation. Each characteristic may have a different audience metric value or weight associated therewith (e.g., some demographics may be more important than others). Any characteristic which can distinguish subscribers may be utilized in determining the audience metric. In some embodiments, the audience metric may track different individuals accessing the same media on a same user device 106. Each media will have an audience metric associated therewith which combines both an online and offline tracking data.

The frequency module 714 determines a frequency metric for each media content. The frequency metric considers a number of times each media content is accessed by each individual. In exemplary embodiments, the media content may be accessed both online (e.g., connected via the network 104) and offline (e.g., via an offline device such as an e-book reader). In one embodiment, the frequency metric may distinguish or provide different metric values or weighting for online access versus offline access of the media content. These values may then be combined into a single frequency metric. Thus, the frequency module 714 determines a frequency metric for each media content that includes both online and offline access activities by the user.

In exemplary embodiments, different media update their content at different frequencies. The more frequently updated the content, the more likely that a subscriber will access the media more frequently. Thus, the frequency metric may factor in this aspect of the media content.

The engagement module 716 determines an engagement metric for each media content. The engagement metric considers a length of time subscribers spend viewing each media content. The engagement metric also tracks type and level of interaction with the media content. For example, a subscriber may click-through on a link of a media content the subscriber is viewing, bookmark a section of the media content the subscriber is viewing, purchase an item advertised on a page viewed by the user, or re-view a section of the media content.

Each type and level of interaction may comprise a different value or weighting metric. Thus, a higher level of interaction may have a higher engagement metric value than a lower level of interaction. For example, a user watching a same portion of a television show repeatedly (e.g., three times) will result in a higher engagement metric score than a user only watching the same portion a single time.

The valuation module 718 takes the aggregated metrics and a value associated with the user (e.g., subscription value and ad generation value) and applies rules to determine a value associated with each media content or user. The rules may comprise business logic or rules that determine a revenue share or a subscription plan price based on a number or weighted factors. Different types of metrics may be utilized by the valuation module 718 in order to determine the valuation based on the rules. For example, two or more of the audience metric, frequency metric, or engagement metric for a particular media content may be used to determine the valuation. In one embodiment, the valuation determination may be based on proportions or different weightings of the metrics. For example, if two different metrics are utilized, then each may provide half of the weighting for the valuation. In other embodiments, the aggregation may be based on different algorithms, which may place more value on one metric over another. For example, the engagement metric may be more important than the frequency metric or demographics (e.g., audience metric). In these embodiments, the algorithm may emphasize the engagement metric (e.g., have the engagement metric comprise a larger weighting in the overall outcome of the valuation).

In a specific example, a subscriber may pay $10 a month for his subscription plan. Thus, the user's value from a subscription perspective is $10. If the system can generate $4 a month from ad revenues due to the demographics associated with the user, then the aggregated value associated with the user is $14 a month. Applying the business logic or rules along with the tracking metrics utilized by the business logic or rules, a determination of a value for each content media in the user's subscription may be determined. For example, if the user spends 80% of his time on the WSJ, then the WSJ may receive 80% of the aggregated value associated with the user (e.g., minus a portion retained by the aggregated media system 102). In one embodiment, the valuation module 718 determines the value associated with the user.

It is noted that the valuation module 718 may be located elsewhere in the aggregated media system. For example, the valuation module 718 may comprise its own server system, or engine.

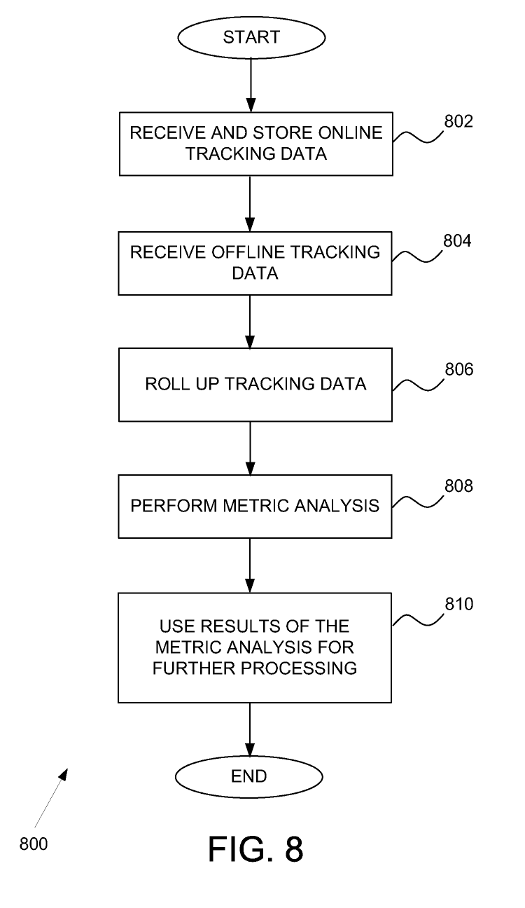

FIG. 8 is a flowchart illustrating an exemplary method 800 for tracking media content interactions by subscribers and utilizing the results of the tracking data. At operation 802, the online tracking data is received and stored. In exemplary embodiments, the online tracking engine 702 continuously tracks online activities of subscribers. The online tracking includes detecting access and download of media content, determining the subscribers that are accessing the media content, and monitoring usage of the media content (e.g., timestamps and various types of interactions with the media content). The online tracking data may be stored to a database for later access and processing.

At operation 804, offline tracking data is received. In exemplary embodiments, the offline tracking engine 704 receives offline tracking data cached at the user devices and stores the offline tracking data in a database. The offline tracking includes detecting access and download of media content, determining the subscribers that are accessing the media content, and monitoring usage of the media content offline. The offline tracking data may be received from the user device when the user device communicatively couples to the aggregated media system 102 via the network 104.

At operation 806, the online and offline tracking data is aggregated. The aggregation may occur at a predetermined time (e.g., every evening), continuously, or be triggered manually by an administrator. At such time, the data aggregation module 708 accesses the one or more databases that store the online and offline tracking data and aggregates the data. In exemplary embodiments, the data aggregation module 708 converts the tracking data into “real world” data. For example, the data aggregation module 708 may take the timestamp, user ID, and action associated with each piece of raw tracking data and convert it into a time period in which a user clicked on a certain number of pages of a particular media content and an amount of time spent on each page. In some embodiments, a portion of the tracking data may be received in real-time by the online tracking engine 702 and offline tracking engine 704.

For example, the aggregation may be a reduction of the collected tracking data from individual observations to collections by, for example user, time, article or advertisement, property, and movement within a publication (e.g., click trail). For instance, collected tracking data may indicate:
User 1 opened document 100 at 9 am.
User 1 left document 100 at 9:30 am and went to document 200.
User 2 opened document 300 at 9:15 am
User 2 left document 300 at 9:16 am by clicking on advertisement A
   Thus, an aggregation for document 100 is 30 minutes read time and one feed to document 200. An aggregation for document 300 is a 1 minute read time and one feed to advertisement A. Similarly, properties that the documents are published from get time and usage credits and if there is movement between properties (e.g., a feed), that movement may also be valued and aggregated.

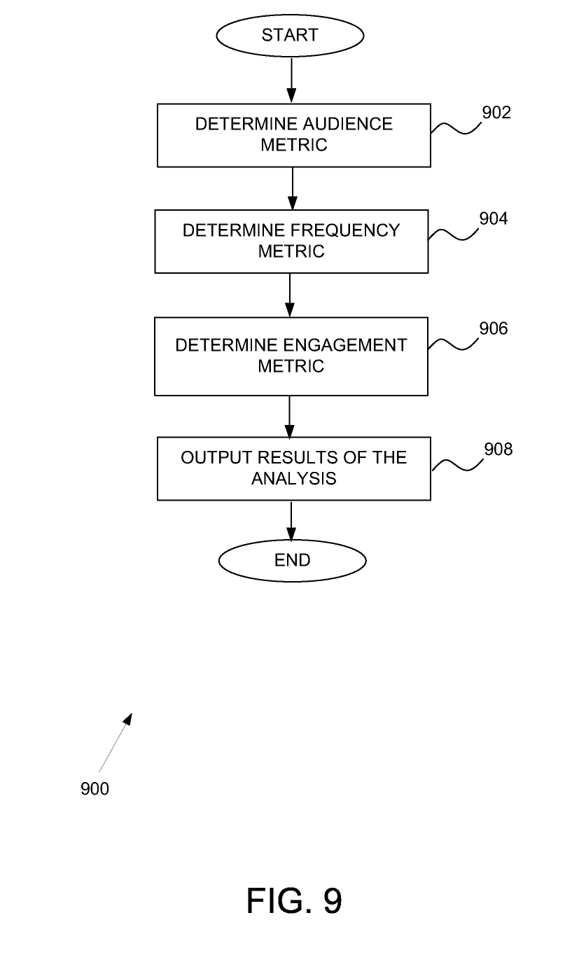

At operation 808, metric analysis is performed on the aggregated tracking data. The metric analysis may be performed, for example, on a monthly basis. The metric analysis will be discussed in more detail in connection with FIG. 9.

At operation 810, results of the metric analysis are used for further processing. In one embodiment, the results may be used to determine revenue sharing among the content providers. In this embodiment, the valuation module 718 may determine a value of a user for each media content accessed by the user based on tracking metrics and a revenue associated with the user. For example, the valuation module 718 may take the frequency and engagement metrics for the user for a particular content media and divide that by a total frequency and engagement metric for the user for the month. This may then determine a proportion of a revenue associated with the user (e.g., subscription payment, amount generated from user demographics and ads) that is allotted to the particular content media.

Depending on business logic or rules associated with the valuation module 718, different metrics (or different weighting for the metrics) may be used to determine valuation. For example, a subscriber may subscribe to both the WSJ and to a local paper and pay $20 a month. The subscriber may spend the majority of his time on the WSJ, so basing the valuation more on the frequency metrics, the WSJ should get the majority of the valuation share (e.g., revenue). However, from an ad perspective, the local paper's ads are more relevant because the subscriber is a local shopper. Thus, in this later embodiment, particular engagement metrics may be more heavily weighted. In another example, the aggregated metrics may be used to rank media content (e.g., a top ten list for each content category) or determine a subscription plan price.

FIG. 9 is a flowchart illustrating an exemplary method 900 for performing aggregated metric analysis (e.g., operation 808). At operation 902, an audience metric is determined for a media content or media. In exemplary embodiments, the audience module 712 determines the audience metric. The audience metric considers the uniqueness of the individuals accessing the media content. Additionally, characteristics of the subscriber may be considered when determining the audience metric. These characteristics and demographics may include, for example, any one or more of gender, geography, income level, education level, or occupation. Each characteristic may have a different audience metric value or score associated therewith. Any characteristic which can distinguish subscribers may be utilized in determining the audience metric. Each media content or media will have an audience metric associated therewith which combines both an online and offline metric. The audience metric comprises demographic information which provides a demographics perspective that may be important to a content provider (e.g., content provider desires to attract certain demographics and a particular value may be associated with that desire) or the aggregated media system.

At operation 904, a frequency metric is determined for a media content. In exemplary embodiments, the frequency module 714 determines the frequency metric. The frequency metric considers a number of times each media content is accessed by each individual. In exemplary embodiments, the media content may be accessed both online (e.g., connected via the network 104) or offline (e.g., via an offline device such as an e-book reader). In one embodiment, the frequency metric may distinguish or provide different metric values for online access versus offline access of the media content. These values may then be combined into a single frequency metric. Thus, the frequency module 714 determines a frequency metric for each media content that includes both online and offline access activities by the subscriber.

At operation 906, an engagement metric is determined for each media content. In exemplary embodiments, the engagement module 716 determines an engagement metric for each media content. The engagement metric considers a length of time subscribers spend viewing or interacting with each media content. The engagement metric may also track types and levels of interaction with the media content. Each type and level of interaction may comprise a different value or scoring metric. Thus, a higher level of interaction will have a higher engagement metric score than a lower level of interaction.

At operation 908, the results for each media content are outputted. The results may then be used by other systems of the aggregated media system for further processing (e.g., in operation 810).

It is appreciated that the methods of FIG. 8-FIG. 9 are exemplary. Alternative embodiments may comprise more, less, or functionally equivalent steps. Additionally, the steps of the various methods may be practiced in a different order. For example, the method 900 may perform the operations for determining audience metrics (operation 902), determining frequency metrics (operation 904), and determining engagement metrics (operation 906) in a different order.

### Modules, Components, and Logic

Additionally, certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain exemplary embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry or in temporarily configured circuitry (e.g., configured by software) may be driven by, for example, cost, time, energy-usage, and package size considerations.

Accordingly, the term module should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Exemplary Machine Architecture and Machine-Readable Medium

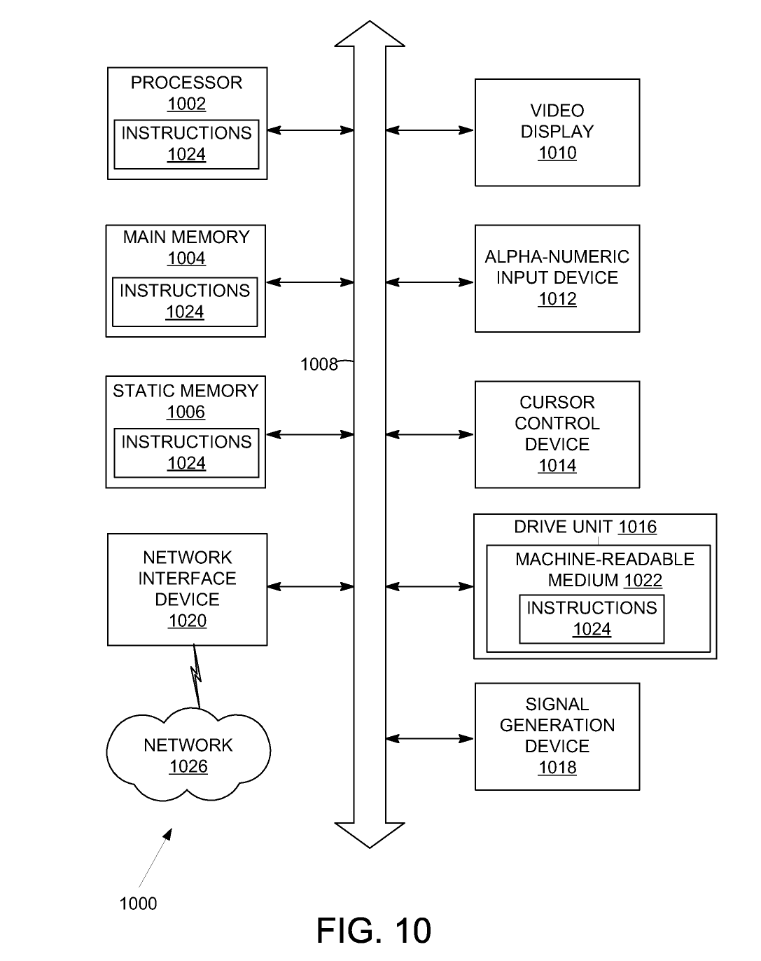

With reference to FIG. 10, an exemplary embodiment extends to a machine in the exemplary form of a computer system 1000 within which instructions for causing the machine to perform any one or more of the methodologies discussed herein may be executed. In alternative exemplary embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1000 may include a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). In exemplary embodiments, the computer system 1000 also includes one or more of an alpha-numeric input device 1012 (e.g., a keyboard), a user interface (UI) navigation device or cursor control device 1014 (e.g., a mouse), a disk drive unit 1016, a signal generation device 1018 (e.g., a speaker), and a network interface device 1020.

### Machine-Readable Medium

The disk drive unit 1016 includes a machine-readable medium 1022 on which is stored one or more sets of instructions 1024 and data structures (e.g., software instructions) embodying or used by any one or more of the methodologies or functions described herein. The instructions 1024 may also reside, completely or at least partially, within the main memory 1004 or within the processor 1002 during execution thereof by the computer system 1000, the main memory 1004 and the processor 1002 also constituting machine-readable media.

While the machine-readable medium 1022 is shown in an exemplary embodiment to be a single medium, the term “machine-readable medium” may include a single medium or multiple media (e.g., a centralized or distributed database, or associated caches and servers) that store the one or more instructions.

The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable medium” shall accordingly be taken to include, but not be limited to, solid-state memories and optical and magnetic media. Specific examples of machine-readable media include non-volatile memory, including by way of exemplary semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

### Transmission Medium

The instructions 1024 may further be transmitted or received over a communications network 1026 using a transmission medium via the network interface device 1020 and utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific exemplary embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the exemplary configurations may be implemented as a combined structure or resource. Similarly, structures and functionality presented as a single resource may be implemented as separate resources.

These and other variations, modifications, additions, and improvements fall within a scope of embodiments of the present invention as represented by the appended claims. The specification and drawings are, accordingly, to be regarded in an illustrative rather than a restrictive sense.

1. A method comprising:
obtaining tracking data at one or more servers, the tracking data including online tracking data and offline tracking data of user interactions with one or more media content, the offline tracking data being locally cached on an offline device when the offline device is not communicatively coupled to the one or more servers;
aggregating, using a processor, the online and offline tracking data over a period of time; and
determining a plurality of tracking metrics for a media content of the one or more media content based on the aggregated online and offline tracking data.

2. The method of claim 1, wherein the determining plurality of tracking metrics comprises determining an audience metric indicating uniqueness of each individual accessing the media content.

3. The method of claim 1, wherein the determining plurality of tracking metrics comprises determining a frequency metric indicating frequency of access of the media content.

4. The method of claim 1, wherein the determining plurality of tracking metrics comprises determining an engagement metric indicating type and level of engagement with the media content.

5. The method of claim 1, further comprising determining a valuation of the media content based on at least one of the plurality of tracking metrics.

6. The method of claim 5, wherein the determining the valuation comprises determining a revenue sharing valuation.

7. The method of claim 5, wherein the determining the valuation comprises determining a subscription plan pricing valuation.

8. The method of claim 5, wherein the determining the valuation comprises determining a valuation associated with a user.

9. The method of claim 1, further comprising providing a tracking application to an offline device to generate the offline tracking data and synchronize the offline tracking data with the server when the offline device is communicatively coupled to the one or more servers.

10. A system comprising:
one or more tracking engines to obtain tracking data at one or more servers, the tracking data including online tracking data and offline tracking data of user interactions with one or more media content, the offline tracking data being locally cached on a offline device when the offline device is not communicatively coupled to the one or more servers;
a data aggregation module to aggregate, using a processor, the online and offline tracking data over a period of time; and
at least one data processing module to determine a plurality of tracking metrics for a media content of the one or more media content based on the aggregated online and offline tracking data.

11. The system of claim 10, wherein the at least one data processing module comprises an audience module to determine an audience metric indicating uniqueness of individuals accessing the media content.

12. The system of claim 10, wherein the at least one data processing module comprises a frequency module to determine a frequency metric indicating frequency of access of the media content.

13. The system of claim 10, wherein the at least one data processing module comprises an engagement module to determine an engagement metric indicating type and level of engagement with the media content.

14. The system of claim 10, further comprising a valuation module to determine a valuation of the media content based on at least one of the plurality of tracking metrics.

15. The system of claim 14, wherein the determined valuation comprises a revenue sharing valuation.

16. A machine-readable storage medium in communication with at least one processor, the machine-readable storage medium storing instructions which, when executed by the at least one processor, provides a method, the method comprising:
obtaining tracking data at one or more servers, the tracking data including online tracking data and offline tracking data of user interactions with one or more media content, the offline tracking data being locally cached on a offline device when the offline device is not communicatively coupled to the one or more servers;
aggregating, using a processor, the online and offline tracking data over a period of time; and
determining a plurality of tracking metrics for a media content of the one or more media content based on the aggregated online and offline tracking data.

17. The machine-readable storage medium of claim 16, wherein the method further comprises determining a valuation of the media content based on at least one of the plurality of tracking metrics.

18. The machine-readable storage medium of claim 17, wherein the determining the valuation comprises determining a revenue sharing valuation.

19. The machine-readable storage medium of claim 17, wherein the determining the valuation comprises determining a subscription plan pricing valuation.

20. The machine-readable storage medium of claim 17, wherein the determining the valuation comprises determining a valuation associated with a user.
